(19) United States
(12) Patent Application Publication
(10) Pub. No.: US 2002/0120495 A1
(43) Pub. Date: Aug. 29, 2002

(54) RETAIL SYSTEMS AND METHODS EMPLOYING A PRODUCT SHELF DISPLAY TO PROVIDE PURCHASE INCENTIVES

(76) Inventors: KEN R. POWELL, ATHENS, GA (US); THOMAS M. HINTZ, INDIANAPOLIS, IN (US); ELEANOR B. MAXWELL, CRAWFORD, GA (US)

Correspondence Address: JEROME D JACKSON, 211 NORTH UNION STREET, SUITE 100, ALEXANDRIA, VA, 22314

(21) Appl. No.: 09/317,439

(22) Filed: May 24, 1999

(51) Int. Cl. G06F 17/60; G06G 1/12; G06K 15/00

(52) U.S. Cl. 705/14; 705/21; 705/20

(57) ABSTRACT

Retail systems and methods employing a product shelf display to provide purchase incentives.

### BACKGROUND OF THE INVENTION

1. Field of the Invention

This invention relates generally to a commercial system and, more particularly, to a system and method of issuing discounts in an incentive program.

2. Description of Related Art

Product promotions employing price discounts are a popular means to stimulate sales of products such as grocery store items. One type of product promotion is a discount coupon. It has been estimated that in-store couponing coupled with advertising increases sales by 544%.

### SUMMARY OF THE INVENTION

It is an object of the present invention to provide an improved system and method for issuing discounts.

To achieve this and other objects of the present invention, there is a method for a system with a plurality of portable cards. The method comprises sending a first signal to a first card in the plurality of portable cards, responsive to a purchased product; selectively sending a second signal to the first card, depending on whether the second signal corresponds to a first signal on the card; receiving the second signal from the first card; receiving a third signal corresponding to a product selected for purchase; and determining an amount due depending on whether the third signal corresponds to a second signal on the first card.

According to another aspect of the present invention, a there is a system for operating with a plurality of portable cards. The system comprises a first card-writer with circuitry configured to write a first signal to a first card in the plurality of portable cards, responsive to a purchased product; a second card-writer with circuitry configured to selectively write a second signal to the first card, depending on whether the second signal corresponds to a first signal on the card; a card-reader with circuitry configured to send second signals from the first card; a signal generator that generates a third signal corresponding to a product selected for purchase; and a determiner an amount due depending on whether the third signal corresponds to a second signal from the card-reader.

### BRIEF DESCRIPTION OF THE DRAWINGS

FIG. 1 is a diagram of a system in accordance with the first preferred embodiment of the present invention.

FIG. 2 is a plan view of the retail store in accordance with a first preferred embodiment.

FIGS. 3A and 3B are another type of view of a part of the first preferred retail store.

FIGS. 4A and 4B are the other type of view of another part of the first preferred retail store.

FIG. 5 is a flow chart of a process performed in the first preferred system.

FIGS. 6A and 6B are a flow chart showing part of the process of FIG. 5 in more detail.

FIGS. 7A, 7B, and 7C are enlarged views of some products shown in FIGS. 4A and 4B.

FIG. 8 is a diagram of a shelf unit shown in FIG. 3A after processing a first customer card.

FIG. 9 is a flow chart of a process performed by the shelf units shown in FIG. 3A and 3B.

FIG. 10 is a block diagram of the first customer card.

FIG. 11 is a diagram of some records on the first customer card.

FIG. 12 is a block diagram of a check-out station shown in FIG. 4A.

FIG. 13 is a block diagram of the shelf unit shown in FIG. 8.

FIG. 14 is a more detailed diagram of some memory contents of the shelf unit.

FIG. 15 is a diagram of some records on a second customer card.

FIG. 16 is a diagram of the shelf unit shown in FIG. 3A after processing the second customer card.

FIG. 17 is a diagram of a table for controlling coupon processing during store checkout transactions.

The accompanying drawings which are incorporated in and which constitute a part of this specification, illustrate embodiments of the invention and, together with the description, explain the principles of the invention, and additional advantages thereof. Throughout the drawings, corresponding elements are labeled with corresponding reference numbers.

### DESCRIPTION OF THE PREFERRED EMBODIMENTS

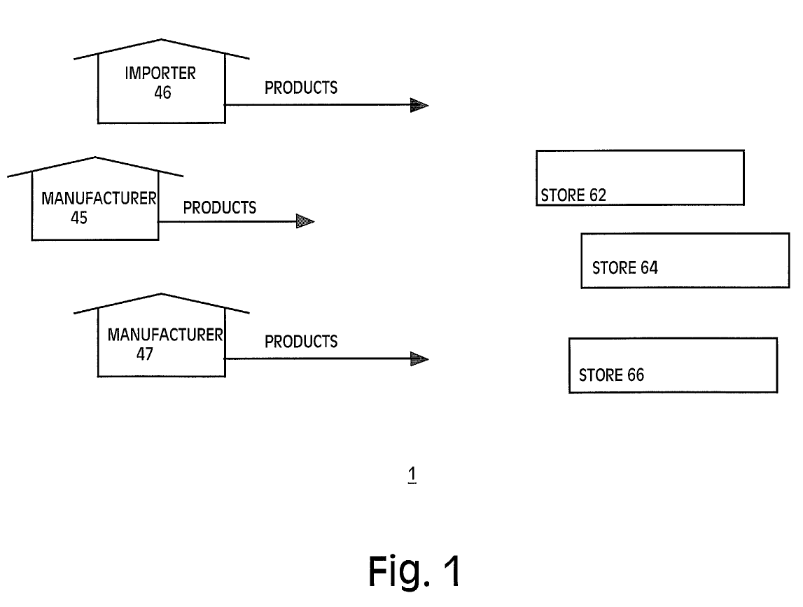

FIG. 1 shows commercial system 1 in accordance with a first preferred embodiment of the present invention. System 1 includes grocery stores 62, 64, 66; manufacturers 45 and 47; and importer 46. Manufacturer 45 is the Delta Corporation. The product line of the Delta Company includes Delta Brand Detergent. Importer 46 is the Alpha Imports Corporation, which obtains products manufactured by other corporations and distributes the products under the name of Alpha Imports. Products distributed by Alpha Imports include Old World Pasta. Manufacturer 47 is the Beta Corporation. The product line of the Beta Corporation includes Lighthouse Light bulbs.

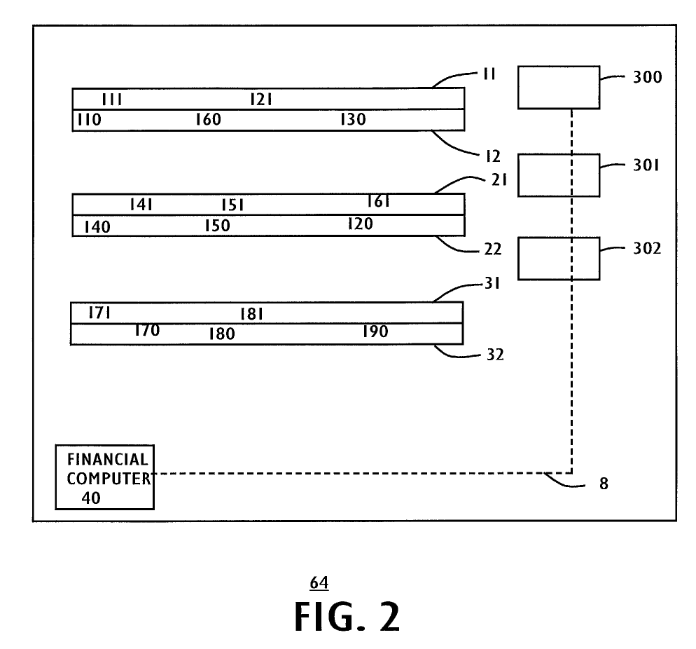

FIG. 2 shows a plan view of store 64. Shelves 11, 12, 21, 22, 31, and 32 include product areas 111, 121, 110, 120, 130, 141, 151, 161, 140, 150, 160, 171, 181, 170, 180, and 190. Each product area includes a plurality of units of a respective product. For example, product area 110 has Delta brand detergent, product area 120 has Old World brand pasta, and product area 130 has Lighthouse brand light bulbs.

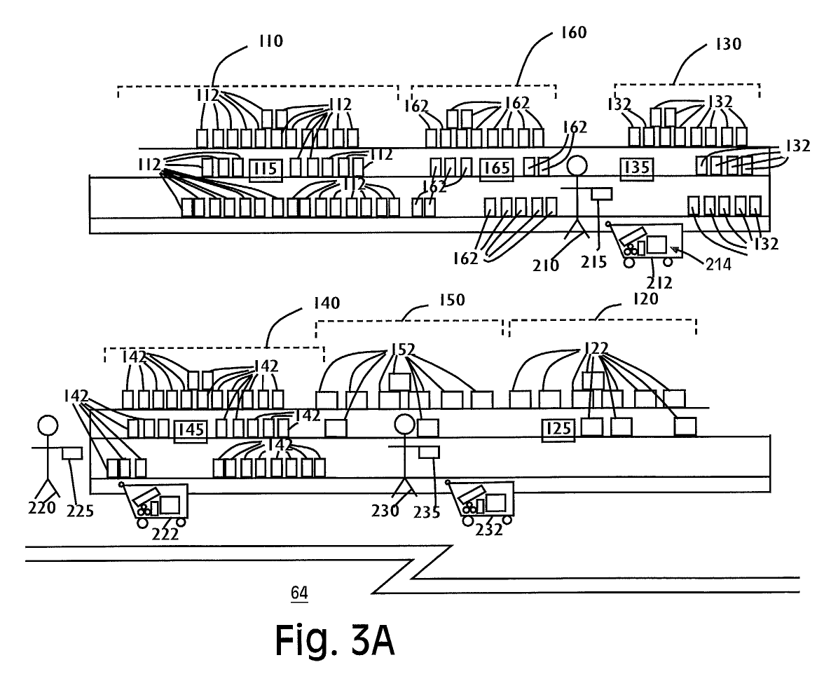

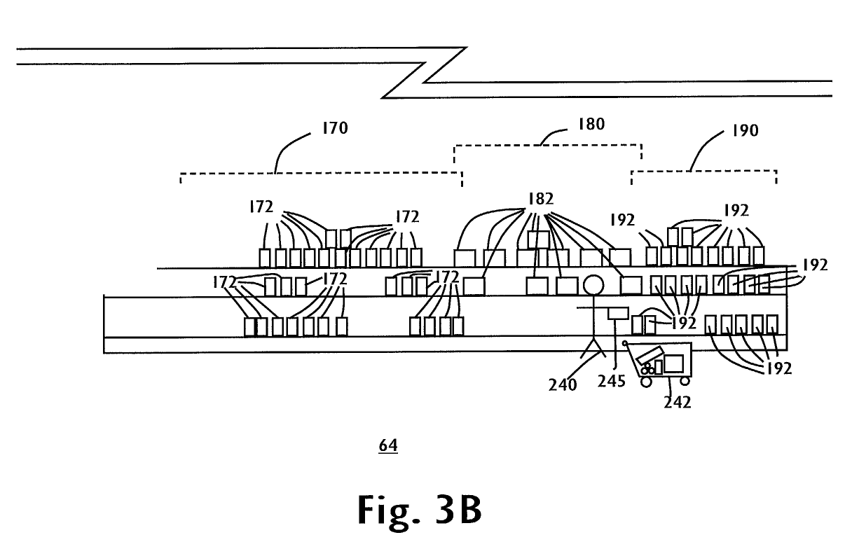

FIGS. 3A, and 3B are each a partial view of 64. Customers 210, 220, 230, 240, 270, 280, 290, 390, 470, 480, and 490 shop in store 64.

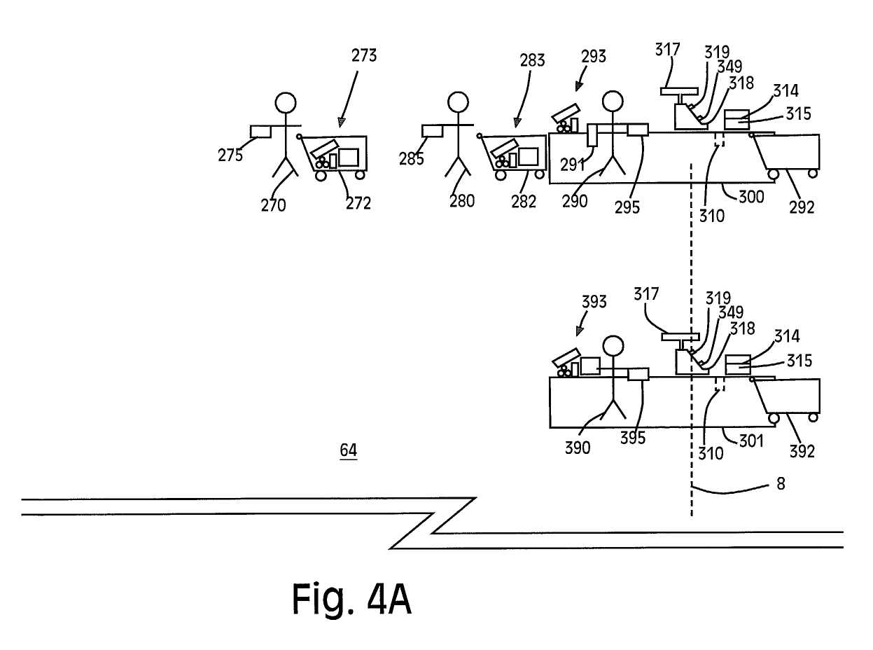

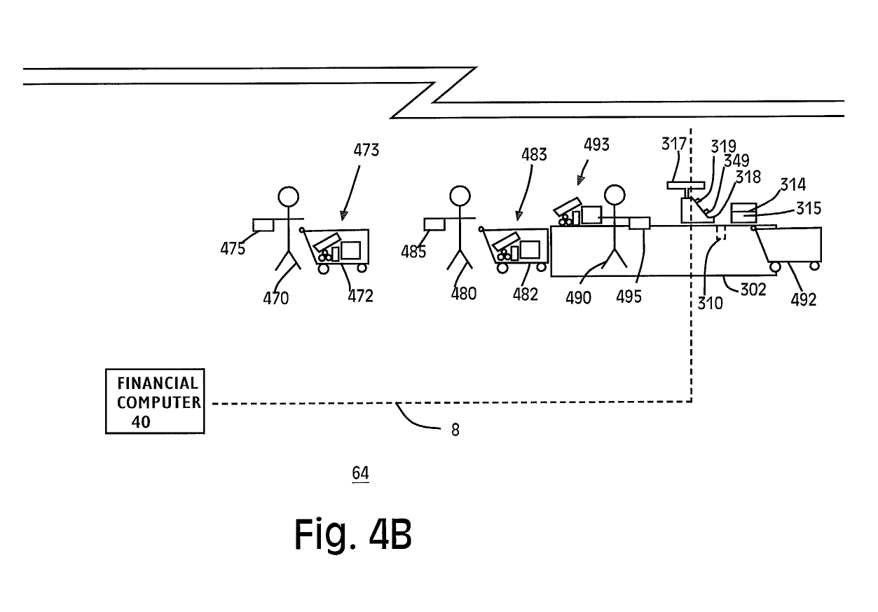

As shown in FIGS. 4A and 4B, financial computer 40 sends product pricing data to checkout stations 300, 301, and 302 via cable 8. Each of checkout stations 300, 301, and 302 includes a UPC bar code reader that detects an optical (electromagnetic) signal reflected from a UPC bar code symbol. Checkout station 300 includes reader/writer 315 having a card interface slot 314, checkout station 301 includes reader/writer 315 having a card interface slot 314, and checkout station 302 includes reader/writer 315 having a card interface slot 314.

Processes performed by the circuitry of system 1 are described below. In this Patent Application, the word circuitry encompasses dedicated hardware, and/or programmable hardware, such as a CPU or reconfigurable logic array, in combination with programming data, such as sequentially fetched CPU instructions or programming data for a reconfigurable array.

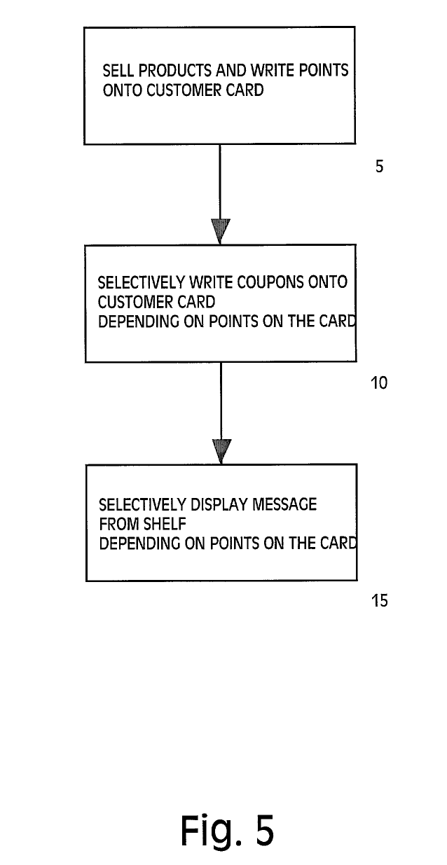

FIG. 5 shows a processing performed in system 1. One of stores 62, 64, or 66 sells products and writes points onto a customer card (step 5). One of stores 62, 64, or 66 selectively writes a coupon onto the customer card from a product shelf (step 10), and displays a message from the product shelf depending on points on the card (step 15). The store that performs step 5 is not necessarily the same store that performs steps 10 and 15.

Checkout Processing in the First Preferred Embodiment—Generation of Points

Upon completion of shopping, each customer brings selected products from the shelves to checkout stations 300, 301, or 302. Customers check out of store 64 by presenting a customer card, allowing the store clerk to insert the presented card into a smart card reader/writer 315. For example, a customer such as customer 290 completes the purchase of her selected products 293 by transferring products 293 from her cart 292 to station 300, and by presenting card 295 for insertion into card interface slot 314; customer 270 completes the purchase of her selected products 273 by transferring products 273 from her cart 272 to station 300, and by presenting card 275; customer 280 completes the purchase of her selected products 283 by transferring products 283 from her cart 282 to station 300, and by presenting card 285;customer 390 completes the purchase of her selected products 393 by transferring products 393 from her cart 392 to station 301, and by presenting card 395; customer 490 completes the purchase of his selected products 493 by transferring products 493 from his cart 492 to station 302, and by presenting card 495;customer 480 completes the purchase of his selected products 483 by transferring products 483 from his cart 482 to station 302, and by presenting card 485;customer 470 completes the purchase of his selected products 473 by transferring products 473 from his cart 472 to station 302, and by presenting card 475. Customer 210 (FIG. 3A) completes the purchase of her selected products 214 by transferring products 214 from her cart 212 to station 300, and by presenting card 215 for insertion into card interface slot 314.

To perform step 5 of FIG. 5, a checkout clerk (not shown) scans each selected product past bar code reader 310, or enters the product selection information manually via keyboard 318. Station 300 thus detects products selected by the customer. After station 300 determines a basic price for a product by processing a message received from computer 40, station 300 displays the description of the product and product price on display 317. Depending on the company of the product, station 300 may also write company points onto the customer's card. Station 300 scans and processes each product 293 in a similar manner. Checkout station 300 determines a total amount due and prints the total amount due on display 317 and on the customer's paper receipt.

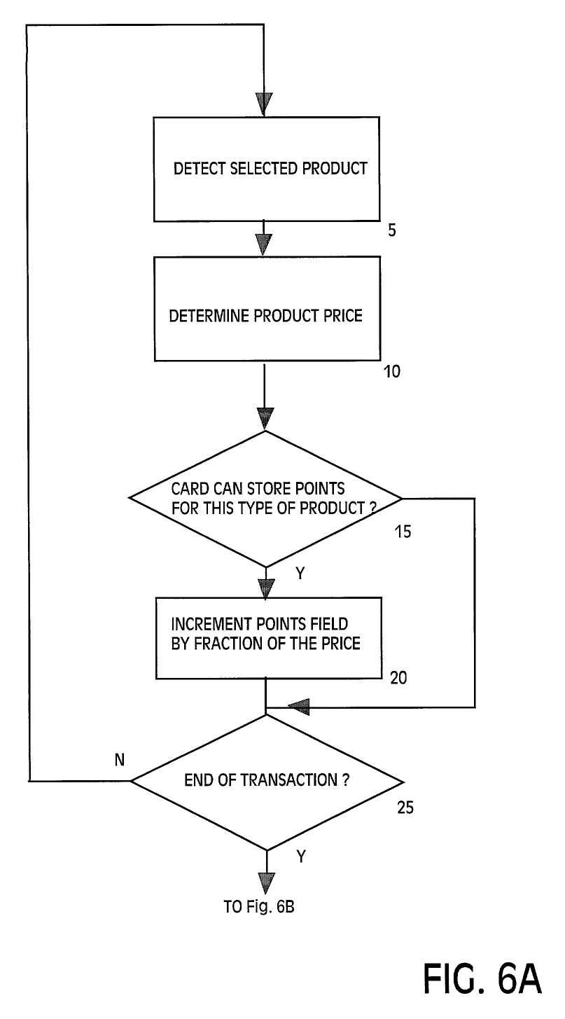

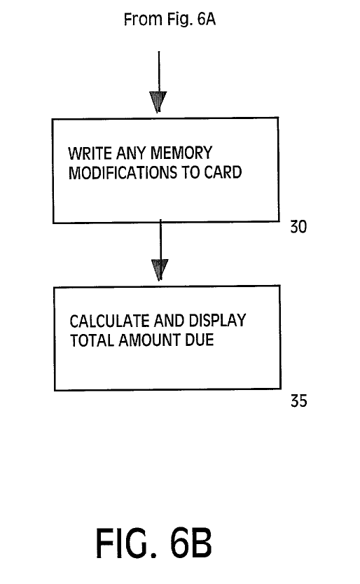

FIGS. 6A and 6B show the processing of step 5 of FIG. 5 in more detail. Station 300 detects a product selected by a customer, by receiving a UPC product code from bar code reader 310 or keyboard 318. (step 5). Station 300 determines a price for the product, by processing a message from financial computer 40. (step 10). Station 300 searches data received from the customer card to determine whether the customer card has a memory area for storing points corresponding to the detected product. (step 15). If the card does contain such a memory area, station 300 increments the points of the memory area by a certain fraction of the price of the product. (step 20). If the checkout transaction for the current customer is complete (step 25), station 300 writes any card memory modifications to the customer card. (step 30). Station 300 determines a total amount due depending on the sum of the product prices from the various executions of step 10, minus any product discounts. Station 300 displays this total amount due on display 317 and the customer's receipt tape. (Step 35).

Store Layout, Coupon Distribution, and Product Selection in the First Preferred Embodiment

As shown in FIGS. 3A and 3B some of the product areas have a respective shelf unit for writing an electronic coupon onto a customer card. Product Area 110 has Shelf unit 115. Product Area 120 has Shelf unit 125. Product Area 130 has Shelf unit 135.

Product Area 110 has bottles of detergent 112 grouped together on multiple shelves. Bottles of detergent 112 are contiguously grouped, meaning that no other product is between any two bottles of detergent 112. No other product is between shelf unit 115 and bottles of detergent 112. Shelf unit 115 is on a shelf under some of the bottles 112 and over some of the bottles 112. In other words, Shelf unit 115 is adjacent to bottles 112 and supported by a shelf that is in vertical alignment with some of the bottles 112.

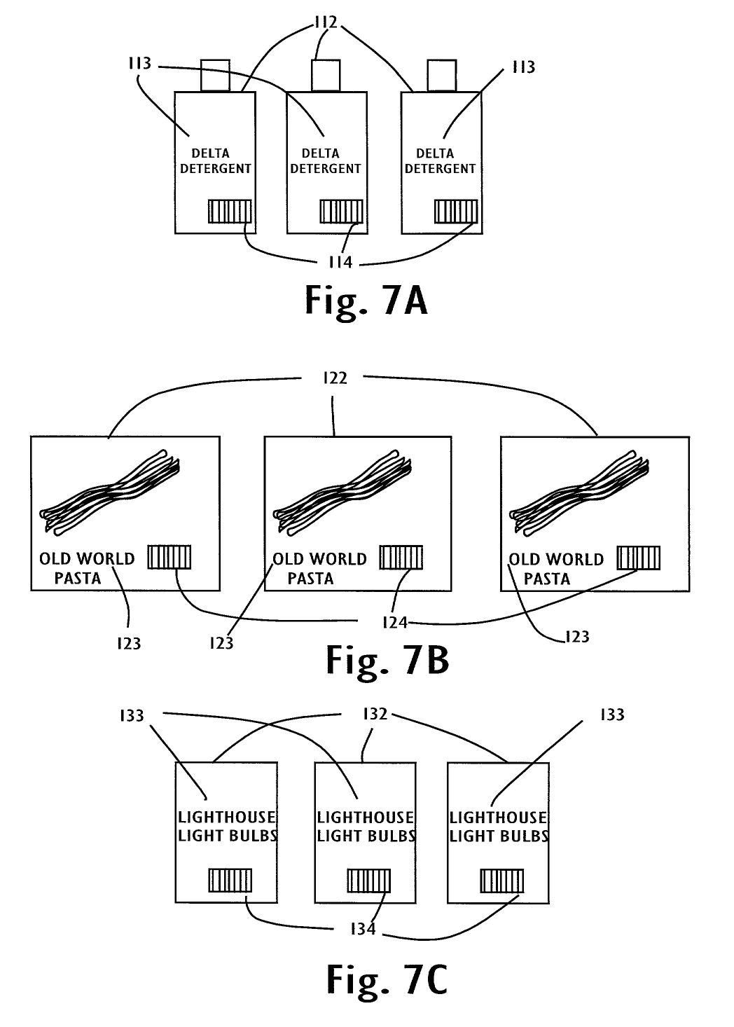

FIG. 7A shows an enlarged view of some of the bottles of detergent 112. Each bottle of detergent has a common Universal Product Code (UPC) symbol 114. Symbol 114 encodes a 12-digit UPC number that is part of a product identification system documented by the Uniform Code Council, Inc., Dayton, Ohio. The first digit is a number system character, which in this case is 0. The next five digits are a company number, which is sometimes called a manufacturer ID. The next 5 digits are an item number. The last digit is a check digit.

Each UPC symbol 114 is a group of parallel lines that encodes a number (0 17075 00003 3) that uniquely identifies Delta Detergent, 17075 being the UPC company number of the Delta Corporation. In other words, symbol 114 is different from UPC symbols of units of other products. Each bottle of detergent 112 also has a common character label 113 that verbally describes the product. Character label 113 is “DELTA DETERGENT.” Label 113 is different from labels of units of other products.

Product Area 120 has boxes of Old World brand pasta 122 contiguously grouped together on multiple shelves. FIG. 7B shows an enlarged view of some of the boxes of pasta 122. Each box of pasta 122 has a common UPC symbol 124, which is a group of parallel lines that encodes a number (0 17031 00005 3) that uniquely identifies Old World pasta, 17031 being the UPC company number of the Alpha Imports Corporation. In other words, symbol 124 is different from UPC symbols of units of other products. Each box of pasta 122 also has a common character label 123 that verbally describes the product. Character label 123 is “OLD WORLD PASTA.” Label 123 is different from labels of units of other products.

Product Area 130 has boxes of Lighthouse brand light bulbs 132 grouped together on multiple shelves. FIG. 7C shows an enlarged view of some of the boxes of light bulbs 132. Each box of light bulbs 132 has a common UPC symbol 134, which is a group of parallel lines that encode a number (0 17054 1017 6) that uniquely identifies Lighthouse light bulbs, 17054 being the UPC company number of the Beta Corporation. In other words, symbol 134 is different from UPC symbols of other products. Each box 132 also has a common character label 133 that verbally describes the product. Character label 133 is “LIGHTHOUSE LIGHT BULBS.” Label 133 is different from labels of other products.

Similarly, other product areas have a set of respective products contiguously grouped together. Respective units of a certain product have a common UPC symbol, different from UPC symbols on units of other products, that uniquely identifies the certain product. Respective units of a certain product have a common label, different from labels on units of other products, that uniquely identifies the certain product. Referring to FIGS. 2, 3A, and 3B product area 140 has bottles of ABC brand ketchup 142 contiguously grouped together, and shelf unit 145. Product area 150 has boxes of Fido brand dog food 152 contiguously grouped together, and no shelf unit. Product area 160 has loaves of Boxer brand bread 162 contiguously grouped together, and shelf unit 165. Product area 170 has cartons of Clover brand milk 172 contiguously grouped together, and no shelf unit. Product area 180 has packages of Chicago brand bacon 182, and no shelf unit. Product area of 190 has packages of Clover brand butter 192 contiguously grouped together, and no shelf unit. Product area 111 has boxes of XYZ brand paper napkins contiguously grouped together. Product area 121 has rolls of XYZ brand paper towel contiguously grouped together. Product area 141 has boxes of Wheat brand crackers contiguously grouped together. Product area 151 has Tropical brand canned fruit contiguously grouped together. Product area 161 has V brand canned vegetables contiguously grouped together. Product area 171 has cans of Chicago brand meat contiguously grouped together. Product area 181 has boxes of Mill brand flour contiguously grouped together.

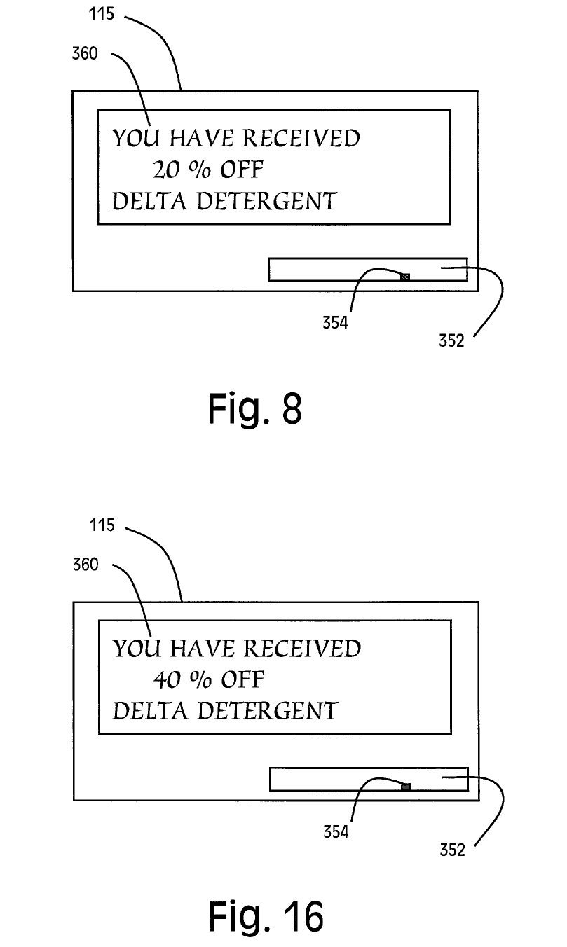

FIG. 8 shows shelf unit 115, including liquid crystal display (LCD) 360, and interface slot 352. Shelf unit 115 has no external wires connecting shelf unit 115 to another device. When customer card 215, for example is in interface slot 352, conductive contact 354 inside interface slot 352 touches a contact on the customer card. Interface slot 352 has other contacts (not shown) for touching the other card contacts.

While shopping in store 64, each of customers 210, 220, 230, 240, 270, 280, and 290 carries his or her respective customer card. A card may store one or more company entries for recording points for a certain company. Each data entry includes a company field and a points field for storing accumulated points earned by purchasing products associated with the company.

To receive an electronic coupon in the store, a customer inserts her respective card into the shelf unit adjacent to the product the customer wishes to purchase, and the shelf unit then selectively writes an electronic coupon onto the card depending on any point entries on the card. In other words, the shelf unit selectively writes an electronic coupon into a memory on the card, in response to a person presenting the card at the shelf unit, and depending on points stored on the card. Shelf unit 115 may store a plurality of different types of coupons for a common product, each coupon having a different discount amount. Shelf unit 115 may select one of the coupon types depending on whether the customer card stores a sufficient quantity of points for the coupon.

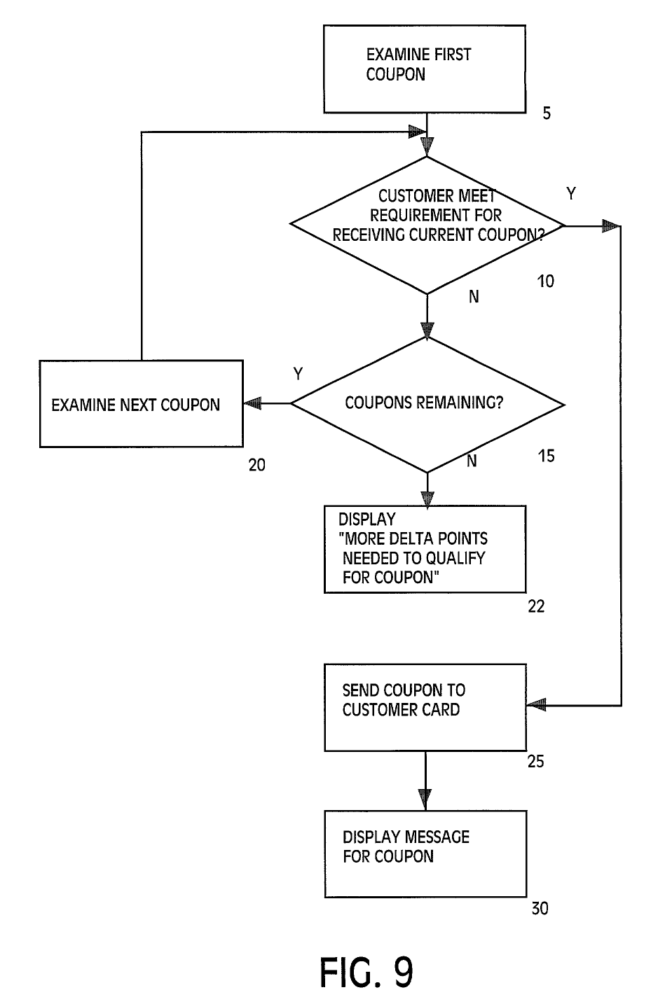

FIG. 9 shows a processing performed by Shelf Unit 115. When a customer presents a card to shelf unit 115, shelf unit 115 examines a first coupon type dispensable by shelf unit 115. (Step 5). Shelf unit 115 examines data from the customer card to determine whether the customer meets the criteria for receiving the currently examined coupon. (Step 10). If the customer does not meet the requirements for the current coupon, shelf unit 115 determines whether there are coupons remaining (step 15). If there are coupons remaining, shelf unit 115 examines the remaining coupon types to determine whether the customer meets the requirements for receiving one of the remaining coupon types. (Steps 20, 10, etc.). If the customer does meet the requirements for receiving one of the coupon types dismissible by shelf unit 115, shelf unit 115 sends the coupon to the customer card (Step 25). And displays a message to the customer indicating the discount quantity of the coupon received. (Step 30).

If the customer is not eligible to receive any of the coupons dispensable by shelf unit 115, shelf unit 115 displays a message to so inform the customer. (Step 22). If the customer has insufficient points to qualify for a coupon in this shelf unit, step 22 may also display how many additional points are required, by displaying the difference between the relevant points on the card and the lowest threshold in table 251.

The customer also removes the product from the shelf and places the removed product into her cart.

Checkout Processing in the First Preferred Embodiment—Redemption of Coupons

After receiving an electronic coupon from a shelf unit and completion of shopping, a customer may bring selected products from the shelves to checkout station 300, 301, or 302, as described above. A customer may redeem the electronic coupons received from a shelf unit by presenting her customer card, allowing the store clerk to insert the presented card into smart card reader/writer 315. Station 300, 301, or 302 then reads the coupon offers from the card. Station 300, for example, performs electronic coupon redemption, by processing the selected products in the context of coupon information from the customer's card to determine discount eligibility. After station 300 determines a basic price for each product by processing a message received from computer 40. Station 300 processes electronic coupons from a customer card, to deduct any discounts from the basic price to calculate and display a total amount due. At the conclusion of the checkout transaction, station 300 voids the shelf unit coupons on the card and the clerk is notified to remove the customer's card from slot 314 and return it to the customer.

More Detailed Description of the First Preferred Embodiment

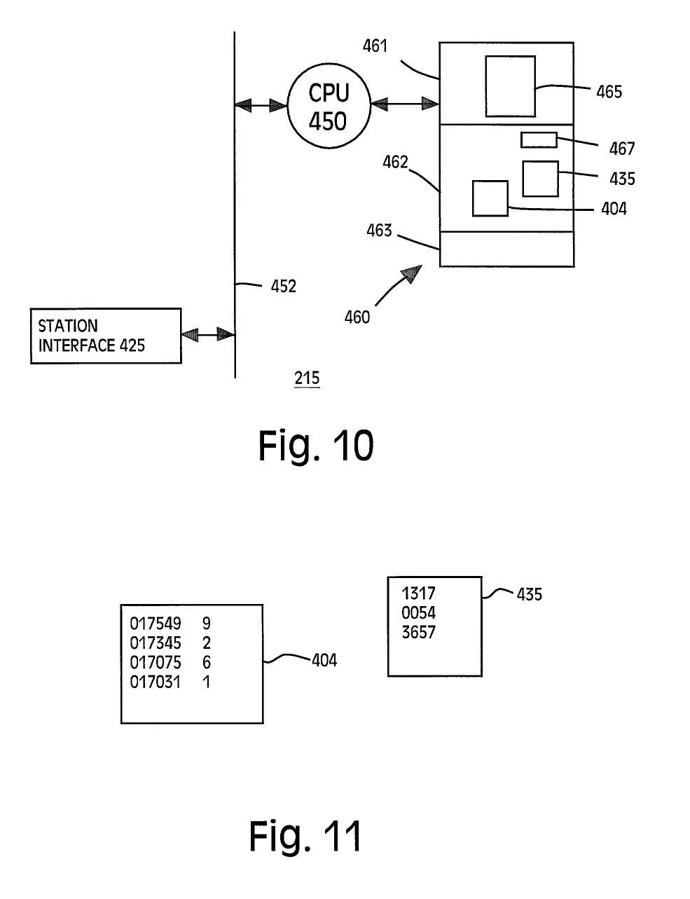

FIG. 10 is a block diagram of customer card 215, including CPU 450, and memory 460. Memory 460 includes three addressable segments: nonvolatile read only memory (ROM) 461; nonvolatile, electrically erasable memory (EEPROM) 462; and memory 463 for temporary storage. Station interface 425 includes a serial to parallel converter for transferring data signals between contacts, on the exterior of card 215, and CPU 450 over parallel bus 452. ROM 461 stores a program 465 executed by CPU 450. EEPROM 462 stores customer card identification data 467. Customer card identification data 467 is a 6 byte field that uniquely identifies the card. For example, identification data 467 in customer card 235 uniquely identifies the card held by customer 230.

EEPROM 462 also stores company points table 404. When purchasing a product at a checkout station, the checkout station may increment the value of a points field in company points table 404.

EEPROM 462 also stores coupon table 465 (product pricing data) received from one or more shelf units. When a customer inserts a customer card into a shelf unit, card CPU 450 may receive a coupon code for the product from the shelf unit and add the code to table 465.

Each of customer cards 235, 245, 275, 285, 295, 395, 475, 485, and 495 have the same hardware structure as card 215.

FIG. 11 shows a simplified, abstract, view of company points table 404 and coupon table 435. Company points table 404 is a data structure within other data structures in EEPROM 462. Each row in table 404 represents an entry in table 404, and each of the two columns represents a field within each entry. The entry on the left is a company identification (ID) field. The entry on the right is a points field that reflects a total value of product, for the company identified by the left field, purchased by customer 215.

Coupon table 435 is a data structure within other data structures in EEPROM 462 of customer card 215. Each row in table 435 represents an entry in table 435. Each entry includes a 4 hexadecimal digit coupon number. Table 435 has three entries, reflecting the fact that customer 210 has received three electronic coupons from coupon dispensing devices. The entry having the coupon number 1317 corresponds to a coupon for purchase of a box of Old World Pasta 122. The entry having the coupon number 0054 corresponds to a coupon for purchase of a box of Lighthouse Light Bulbs 134. The entry having the number 3657 corresponds to a coupon for purchase of detergent bottles 112.

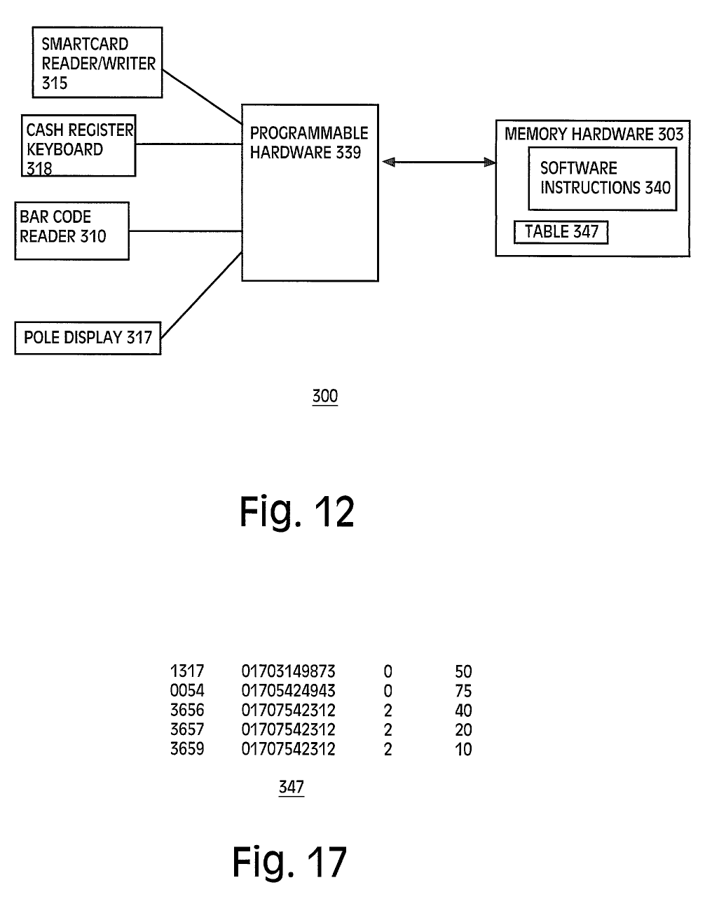

FIG. 12 is a block diagram of checkout station 300. Programmable hardware 339 executes software instructions 340 in memory hardware 303. Cash register keyboard 318 allows manual entry of alpha-numeric data. Bar code reader 310 generates a bar code signal, and sends the bar code signal to hardware 339. Poll display 317 displays product data in response to signals from hardware 339. Hardware 339 and software instructions 340 act to receive electronic coupons from a customer card, via reader/writer 315. Memory hardware 303 stores redemption control table 347, which enables hardware 339 to determine if a product has a corresponding electronic coupon offer.

When station 300 detects insertion of a customer card into reader/writer 315, station 300 reads company points table 404 and coupon table 435 into temporary versions of tables 303 and 435 in memory hardware 303. After detecting a product selected by the customer (See FIG. 6A step 5), hardware 339 searches the company identification field of table 404 for a number system code and company number matching the number system code and company number of the UPC product code. (See Fig. A step 15). If hardware 339 finds such a matching entry in table 404, hardware 339 increments the points field by a predetermined fraction of the product price. (See FIG. 6A step 20). At the conclusion of the checkout transaction, hardware 339 writes the temporary versions of tables 404 and 435, stored in memory hardware 303, to the customer card. (See FIG. 6B step 30).

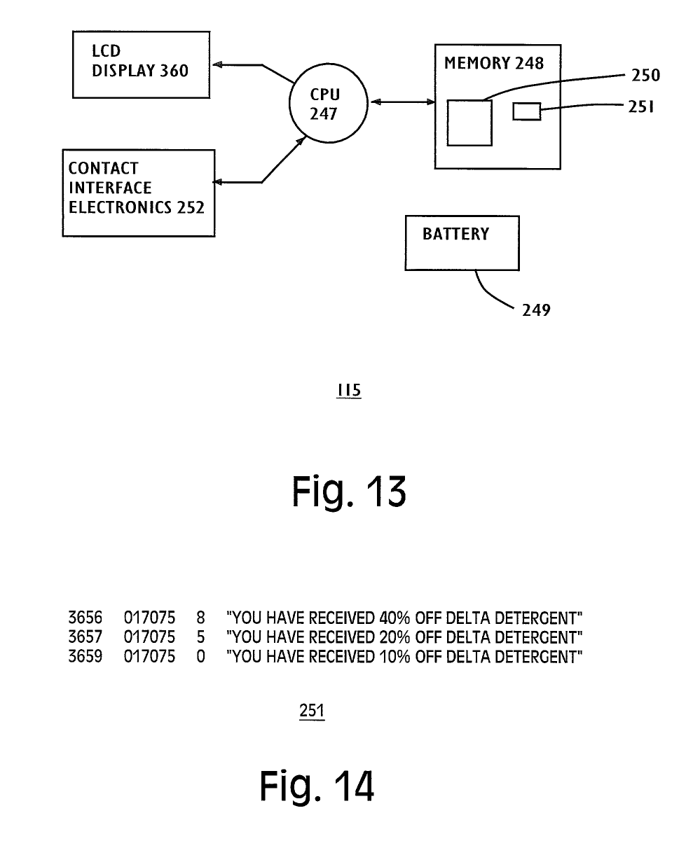

FIG. 13 shows a block diagram of shelf unit 115, including CPU 247, nonvolatile memory 248, card contact interface 252, and battery 249. Memory 248 stores program 250, executed by CPU 247, and offer table 251. Memory 248 may include sections of ROM and EEPROM.

FIG. 14 shows offer table 251. Each row in table 251 represents an entry in table 251. Each of the four columns represents a field in each entry. The first column represents a coupon ID field. The second column represents a company ID field. The third column represents a point threshold field for the coupon. The fourth column represents a message field to be displayed if shelf unit 115 sends the coupon to a customer.

When a person inserts a card into slot 352 of shelf unit 115, a switch (not shown) in slot 352 alerts CPU 247 that a card has been inserted into the slot. Subsequently, CPU 247 causes contact interface electronics 252 to reset the card. CPU 252 then receives a header record and company points table 404 from the card. CPU 247 first examines the entry in table 251 having the highest point threshold field, which in this case would be the entry having the point threshold field of 8. (See FIG. 9 step 5). CPU 247 decides that the customer is eligible to receive the coupon of the current entry in table 251 and only if the customer ID field of the current entry of table 251 matches one of the company ID fields of table 404 and the points field of any matching entry and table 404 is greater than or equal to the point threshold field and the current entry in table 251. (See FIG. 9 step 10).

If the customer card satisfies the criteria for an entry and table 251, CPU 247 appends the coupon ID field of the matching entry to coupon table 435 on the customer card. CPU 247 also decrements the points field of the matching entry of points table 404 and writes the updated table 404 to the customer card. (See FIG. 9 step 25). CPU 247 then sends the message field of the matching entry in table 251 to LCD display 360. (See FIG. 9 step 30).

Thus, referring to FIGS. 8, 9, 11, and 14, when customer 210 presents card 215 to shelf unit 115, unit 115 effects the second entry in table 251 by displaying “20% OFF” on LCD display 360 and writing 3657 into table 435 of card 215. More specifically, the third entry of table 404 of card 215 has a company ID field of 017075, which matches the company ID of the second entry in table 251; and the third entry of table 404 has a points field of 6, which is greater than the points threshold of the second entry in table 251 (6).

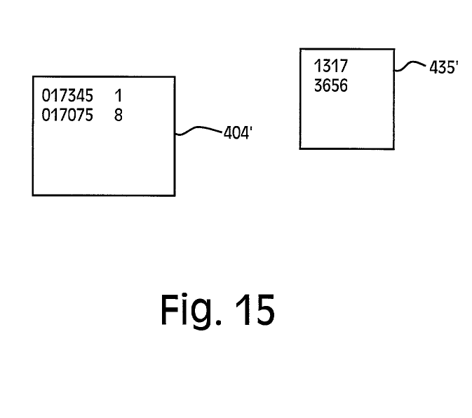

FIG. 15 shows a simplified, abstract, view of company points table 404′ and coupon table 435′ stored on customer card 235. FIG. 16 shows shelf unit 115 after customer 230 presents card 235 to shelf unit 115. In other words, referring to FIGS. 16, 9, 15, and 14, when customer 230 presents card 235 to shelf unit 115, unit 115 effects the first entry in table 251 by displaying “40% OFF” on LCD display 360 and writing 3656 into table 435′ of card 235. More specifically, the second entry of table 404′ of card 235 has a company ID field of 017075, which matches the company ID of the first entry in table 251; and the second entry of table 404′ has a points field of 8, which is equal to the points threshold of the first entry in table 251 (8).

FIG. 17 is a simplified diagram of redemption control table 347 stored in card interface station 300. Each row in FIG. 17 represents an entry in table 347, and each of the 4 columns shown represents an entry field. A redemption control table may include additional entries for additional coupon offers, and additional fields for recording other types of information.

The first field in FIG. 17 is a coupon ID stored as 4 hexadecimal digits. The second field is a UPC product code corresponding to the coupon ID. The second field is stored as binary coded decimal. The third field is a reward type. A reward type of 2 represents a percent off coupon, and a reward type of 0 represents a cents off coupon.

The fourth field in FIG. 17 is the reward quantity.

The first entry shows a reward of 50 cents off because the reward type is 0. The first entry is for a product having a product number of 49873, from a company having a company ID of 017031.

The second entry shows a reward quantity of 75 cents off because the reward type is 0.

The second entry is for a product having a product number of 24943, from a company having a company ID of 017054.

The third entry shows a reward quantity of 40 percent because the reward type field is 2. The third entry is for a product having a product number of 42312, from a company having a company ID of 017075. The company ID 017075 identifies the Delta Company.

The fourth entry shows a reward quantity of 20 percent for the product having the product number 42312 from the company having the ID 017075, which is the Delta Company.

The fifth entry shows a reward quantity of 10 percent for the product having the product number 42312 from the company having the company ID 017075, which is the Delta Company.

Thus, table 347 stores three coupon entries for the same product, each coupon entry having a different reward value.

Checkout stations 301 and 302 each have the same capabilities and hardware as checkout station 300, cash register systems 331 and 332 each have the same capabilities and hardware as cash register station 300, and card interface systems 301 and 302 each have the same capabilities and hardware as card interface station 300.

Processing of step 35 of FIGS. 6A and 6B will now be described in more detail. When hardware 339 receives a valid UPC product code from reader 310 or keyboard 318, hardware 339, hardware 339 adds the product code to a basket list for the current customer. Hardware 339 searches for the received product code in the second field of redemption control table 347, which enables hardware 339 to determine if the product has a corresponding electronic coupon offer. If the product does have an electronic coupon offer, hardware 339 searches coupon table 435 from the customer card to confirm that the customer has the coupon on her card. If the customer has the coupon on her card and qualifier conditions are satisfied for the coupon, hardware 339 adjusts the total amount due by the discount amount of the coupon.

Programmable hardware may include an IBM 4680-4690 Point of Sale (POS) System. Programable hardware 339 may include two CPUs, as disclosed in copending application Ser. No. 09/301,749 of KEN R. POWELL, KEVIN W. HARTLEY, ELEANOR B. MAXWELL, and COREY C. SNOOK for COMPUTER SYSTEM CONFIGURATION AND METHOD FOR A STORE, filed Apr. 29, 1999, the contents of which is herein incorporated by reference. Alternately, hardware 339 may be a single CPU having electronic coupon, or other discount, processing integrated with conventional UPC product scanning and price lookup. Memory hardware 303 may include two independent memories or may be an integrated memory.

Alternatives, to the disclosed coupon ID and matching of a product code in table 347 described above, include a wildcard scheme, or the family-code-based U.P.C. coupon-product(s) correspondence scheme promulgated by the Uniform Code Council Uniform Code Council, Inc., Dayton, Ohio.

Monitoring certain types of electronic coupon dispensers is a subject of copending application Ser. No. 09/301,748 of KEN R. POWELL, KEVIN W. HARTLEY, THOMAS M. HINTZ, ELEANOR B. MAXWELL, and COREY C. SNOOK for SYSTEM AND METHOD EMPLOYING PORTABLE CARDS TO MONITOR A COMMERCIAL SYSTEM, filed Apr. 29, 1999, the contents of which is herein incorporated by reference.

A scheme of programming shelf units and checkout stations is a subject of copending application Ser. No. 09/301,747 of KEN R. POWELL, ELEANOR B. MAXWELL, and COREY C. SNOOK for SYSTEM AND METHOD EMPLOYING A PORTABLE CARD TO CONFIGURE A STORE FOR PRODUCT PROMOTION, filed concurrently with the instant application, the contents of which is herein incorporated by reference.

Conclusion

Additional advantages and modifications will readily occur to those skilled in the art. The invention in its broader aspects is therefore not limited to the specific details, representative apparatus, and illustrative examples shown and described. Accordingly, departures may be made from such details without departing from the spirit or the scope of Applicants' general inventive concept. The invention is defined in the following claims.

What is claimed is:

1. A method for a system with a plurality of portable cards, the method comprising:
sending a first signal to a first card in the plurality of portable cards, responsive to a purchased product;
selectively sending a second signal to the first card, depending on whether the second signal corresponds to a first signal on the card;
receiving the second signal from the first card;
receiving a third signal corresponding to a product selected for purchase; and
determining an amount due depending on whether the third signal corresponds to a second signal on the first card.

2. The method of claim 1 wherein sending a second signal includes
selectively sending a selected one of a plurality of second signals, depending on the first signal.

3. The method of claim 1 wherein selectively sending a second signal includes selectively sending a second signal depending on whether the first and second signals correspond to a common business entity.

4. The method of claim 3 wherein selectively sending a second signal further depends on a value of the first signal.

5. The method of claim 1 wherein selectively sending a second signal includes
selectively sending a second signal depending on whether the first and second signals correspond to a common company.

6. The method of claim 5 wherein selectively sending a second signal further depends on a value of the first signal.

7. The method of claim 1 wherein sending the first signal includes
receiving the first signal from the first card;
modifying the first signal responsive to the purchased product; and
sending the first signal to the card.

8. The method of claim 7 wherein the first signal includes points, and the modifying step includes increasing a quantity of points.

9. The method of claim 1 wherein the system further includes a shelf, units of a product supported by the shelf, and wherein the second signal corresponds to the product, and wherein the method further includes displaying the second signal from the shelf.

10. The method of claim 1 wherein the system further includes a shelf, units of a product supported by the shelf, and wherein the second signal corresponds to the product, and wherein the method further includes
displaying the second signal from the shelf, in response to the first signal.

11. A system for operating with a plurality of portable cards, the system comprising:
a first card-writer with circuitry configured to write a first signal to a first card in the plurality of portable cards, responsive to a purchased product;
a second card-writer with circuitry configured to selectively write a second signal to the first card, depending on whether the second signal corresponds to a first signal on the card;
a card-reader with circuitry configured to send second signals from the first card;
a signal generator that generates a third signal corresponding to a product selected for purchase; and
a determiner an amount due depending on whether the third signal corresponds to a second signal from the card-reader.

12. The system of claim 11 further including a housing, wherein the card reader and the first card writer are in the housing.

13. The system of claim 11 wherein the second card-writer includes a memory that stores a plurality of second signals and a plurality of criteria signals.

14. The system of claim 13 wherein the second card-writer includes a comparator that compares the first and criteria signals.

15. The system of claim 14 wherein the first signal corresponds to one of a plurality of companys.

16. The system of claim 11 wherein a product, immediately adjacent to the second card
writer has a bar code identifying a first company, and the second signal corresponds to the first company.

17. The system of claim 11 wherein the second card-writer includes a comparator for comparing the first signal to a threshold.

18. The system of claim 11 wherein sending the first card-writer includes
logic to receive the first signal from the first card;
logic to modify the first signal responsive to the purchased product; and
logic to send the first signal to the card.

19. The system of claim 11 further including a shelf, units of a product supported by the shelf, and wherein the second signal corresponds to the product, and wherein the system further includes a display for displaying the second signal from the shelf.

20. The system of claim 11 further including a shelf, units of a product supported by the shelf, and wherein the second signal corresponds to the product, and wherein the system further includes a display the second signal from the shelf, in response to the first signal.
